(19) United States
(12) Patent Application Publication
(10) Pub. No.: US 2026/0229430 A1
(43) Pub. Date: Aug. 6, 2026

(54) VACUUM CIRCUIT BREAKER

(71) Applicant: HD HYUNDAI ELECTRIC CO., LTD., Seongnam-si (KR)

(72) Inventor: Keon-Woo KIM, Seongnam-si (KR)

(21) Appl. No.: 19/150,909

(22) PCT Filed: Aug. 22, 2023
(86) PCT No.: PCT/KR2023/012382

§ 371 Date: Jul. 24, 2025

(30) Foreign Application Priority Data
Mar. 14, 2023 (KR) 10-2023-0032971

(51) Int. Cl. H01H 33/662; H01H 33/664

(52) U.S. Cl. CPC H01H 33/66238; H01H 33/664

(57) ABSTRACT

A vacuum circuit breaker includes: a pressure vessel filled with insulating gas at a predetermined pressure; a vacuum interrupter disposed inside the pressure vessel and provided with a fixed electrode and a movable electrode which are in a vacuum tube in a vacuum state; a bellows provided to seal a gap between the vacuum tube and the movable electrode; a movable rod which has one end connected to an end of the movable electrode by means of an insulation link, extends through the pressure vessel, and can reciprocate in an axial direction thereof while maintaining air-tightness therebetween; a drive rod which is disposed outside the pressure vessel and at the other end of the movable and transmits a drive force of a drive part to the movable rod; and a contact pressure spring having one end supported by the movable rod and the other end supported by the drive rod.

### TECHNICAL FIELD

The present disclosure relates to a vacuum circuit breaker capable of applying an appropriate self-closing force to secure performance of a vacuum interrupter disposed in a pressure vessel.

### BACKGROUND ART

In general, a vacuum circuit breaker may be a type of circuit breaker installed in a high-voltage power system to protect the power system by cutting off a circuit when a dangerous situation such as short-circuit, overcurrent, or the like occurs, and may be designed by utilizing excellent insulation performance and arc-extinguishing power in a vacuum state.

A core component of such a vacuum circuit breaker may be a vacuum interrupter. The vacuum interrupter may include a fixed electrode and a movable electrode that may be contacted or separated from the fixed electrode in a sealed vacuum tube, and may perform functions of electrifying and cutting off the circuit by contacting and separating the fixed electrode and the movable electrode.

In this case, since the movable electrode should perform linear movement to come into contact with or be separated from the fixed electrode while maintaining the vacuum state in the vacuum interrupter, a bellows may be installed around the movable electrode.

An interior of the vacuum interrupter may be in a vacuum state, and an exterior thereof may be surrounded by a pressure vessel, to which gas pressure may be applied. Since the gas pressure applied in the pressure vessel has a very significant effect on operating characteristics of the vacuum interrupter, an effect of gas pressure should be considered when designing a driving unit or selecting capacity.

For example, when the vacuum circuit breaker is applied to an ultra-high-voltage gas-insulated switch (hereinafter referred to as GIS) or the like, self-closing force of the vacuum interrupter may be changed as the gas pressure in the pressure vessel is changed depending on an operating temperature of the GIS. When the self-closing force has an inappropriately large value, an unnecessarily large degree of force may be required on the driving unit or an uneven contact load may be caused on the electrodes, which ultimately has negative effects on breaking performance of the vacuum interrupter and the vacuum circuit breaker.

### DISCLOSURE OF INVENTION

### Technical Problem

The present disclosure aims to provide a vacuum circuit breaker capable of applying an appropriate self-closing force for securing performance of a vacuum interrupter disposed in an internal space of a pressure vessel, to stably maintain breaking performance regardless of a change in operating temperature.

In addition, another object of the present disclosure is to provide a vacuum circuit breaker capable of operating with the same driving force through a design capable of applying an appropriate self-closing force.

### Solution to Problem

According to an aspect of the present disclosure, a vacuum circuit breaker may include a pressure vessel filled with an insulating gas of a predetermined pressure; a vacuum interrupter disposed in an internal space of the pressure vessel and having a fixed electrode and a movable electrode in a vacuum tube having a vacuum state; a bellows provided to seal a gap between the vacuum tube and the movable electrode; a movable rod having one end connected to an end portion of the movable electrode via an insulating link, and capable of penetrating the pressure vessel and reciprocating in an axial direction while maintaining air-tightness; a driving rod disposed on the other end of the movable rod in an external space of the pressure vessel and transmitting a driving force of a driving unit to the movable rod; and a contact pressure spring having one end supported by the movable rod and the other end supported by the driving rod, wherein a ratio of self-closing force to a minimum input contact pressure in the vacuum interrupter is set to be a predetermined ratio.

The ratio of self-closing force to a minimum input contact pressure in the vacuum interrupter may have a range more than 0 and equal to or less than 0.1.

### Advantageous Effects of Invention

According to an aspect of the present disclosure, since deviation of self-closing force according to a change of a usage temperature does not affect performance of a vacuum circuit breaker, an effect of eliminating variation of a driving force may be obtained.

In addition, according to an embodiment of the present disclosure, an effect of eliminating unnecessary excessive driving force design elements may be achieved by limiting self-closing force to a predetermined range to minimize influence of self-closing force on the entire driving system.

### BRIEF DESCRIPTION OF DRAWINGS

FIG. 1 is a view illustrating a vacuum circuit breaker according to an embodiment of the present disclosure.

### Best Mode for the Invention

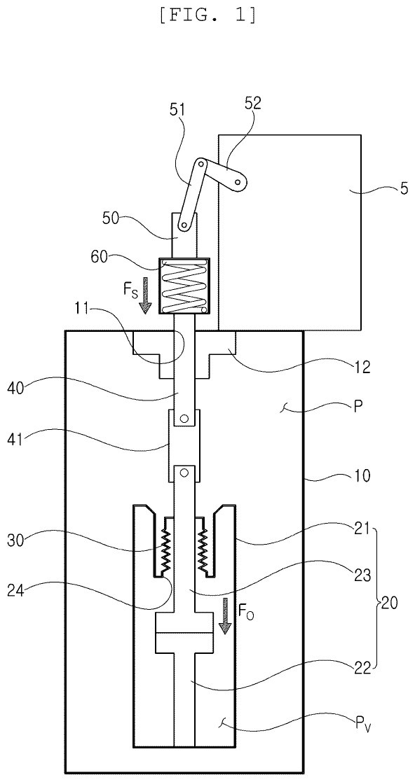

Hereinafter, the present disclosure will be described in detail through an illustrative drawing. FIG. 1 is a view illustrating a vacuum circuit breaker according to an embodiment of the present disclosure.

A vacuum circuit breaker according to an embodiment of the present disclosure may include a pressure vessel 10, a vacuum interrupter 20, a bellows 30, a movable rod 40, a driving rod 50, and a contact pressure spring 60.

The pressure vessel 10 may be a sealed vessel housing the vacuum interrupter 20 of the vacuum circuit breaker. An external space of the pressure vessel may be subjected to an atmospheric pressure, and an internal space of the pressure vessel may be filled with an insulating gas having a pressure, equal to or higher than the atmospheric pressure. For example, a gas pressure in the pressure vessel may be 7.5 kgf/cm², but is not necessarily limited thereto.

The pressure vessel 10 may have a through-hole 11 formed on one side, such that the movable rod 40 may penetrate through and reciprocate in the pressure vessel. A sealing member 12 maintaining internal air-tightness of the pressure vessel may be interposed between the through-hole and the movable rod.

The vacuum interrupter 20 may be disposed in the internal space of the pressure vessel 10, and may include a fixed electrode 22 and a movable electrode 23 installed in a vacuum tube 21. The vacuum tube may be composed of a member formed of an insulating material, for example, in a cylindrical shape, but is not necessarily limited thereto. An internal space of the vacuum tube may be in a vacuum state close to 0 bar.

In the vacuum interrupter 20, the fixed electrode 22 may be installed to be fixed in the internal space of the vacuum tube 21.

In the vacuum interrupter 20, the movable electrode 23 may reciprocate in an axial direction, and one end portion may be in contact with or separated from the fixed electrode 22, and the other end portion may be disposed to protrude in an outward direction through a through-hole 24 of the vacuum tube 21.

The bellows 30 may have one side fixed to the vacuum tube 21 of the vacuum interrupter 20, and may seal a gap between the through-hole 24 of the vacuum tube and the movable electrode 23. The bellows may be contracted and extended in the axial direction, such that a length in the axial direction may be changed.

For example, the bellows 30 may be installed such that one end surrounds the through-hole 24 and the other end surrounds an outer circumferential surface of the movable electrode 23. The bellows may be disposed in this manner, such that the internal space of the vacuum tube 21 may be maintained in a vacuum state even though the bellows expands and contracts according to an operation of the movable electrode.

Therefore, the bellows 30 may separate a vacuum pressure in the vacuum interrupter 20 and a gas pressure in the pressure vessel 10.

The movable rod 40 may have one end connected to the other end portion of the movable electrode 23 via an insulating link 41, and may transmit driving force by a driving unit 5 to the movable electrode. The movable rod may reciprocate in an axial direction while maintaining internal air-tightness of the pressure vessel 10. To this end, the movable rod may be installed to slide by penetrating an interior of the sealing member 12 installed in the through-hole 11 of the pressure vessel in a low-friction state.

This movable rod 40 may receive the driving force of the driving unit 5 from the driving rod 50, and may transmit the same to the movable electrode 23. In addition, the movable rod 40 may receive self-closing force of the vacuum interrupter 20 due to the gas pressure in the pressure vessel 10 and/or force due to a pressure difference between the internal space of the pressure vessel and the external space of the pressure vessel.

The insulating link 41 may be formed of an insulating material to electrically insulate the movable electrode 23 and the driving unit 5, and may transmit driving force from the movable rod 40 to the movable electrode 23.

The driving rod 50 may be disposed on the other end of the movable rod 40 outside the pressure vessel 10, and may transmit the driving force from the driving unit 5 to the movable rod. The driving rod may reciprocate in an axial direction of the movable rod.

The driving rod 50 may be connected to the driving unit 5 via a driving link 51 and a rotary lever 52, and may receive the driving force from the driving unit. The rotary lever may be connected to the driving unit directly or by a reducer or the like, to rotate.

The driving unit 5 may include, for example, a motor or the like, and may be operated by a control command or a manual operation of a user to generate power, to rotate the rotary lever 52.

Rotational force of the rotary lever 52 may be transmitted to the driving link 51, and a position of the driving link may be changed according to rotation of the rotary lever, such that the driving rod 50 may reciprocate in an axial direction of the movable rod 40.

The contact pressure spring 60 may be disposed between the movable rod 40 and the driving rod 50, and one end may be supported by the movable rod and the other end may be supported by the driving rod. The contact pressure spring may be formed as, for example, a compression coil spring, but is not necessarily limited thereto, and other spring of any shape may be adopted as long as it applies force to the movable rod 40 toward the fixed electrode 22.

The contact pressure spring 60 may perform a role of pressurizing the movable electrode 23 and the fixed electrode 22 when the vacuum circuit breaker is input. The contact pressure spring which was under an assembly load in an open state may be compressed when the movable electrode is input, and may provide a current-conducting contact pressure between the electrodes by pressing the electrodes in the vacuum interrupter 20 with an increased operating load. In addition, the contact pressure spring may perform a role of absorbing shock or vibration that occurs when the vacuum circuit breaker is opened due to short-circuit current.

For example, when the vacuum circuit breaker is applied to a GIS of an ultra-high voltage or the like, a gas pressure in the pressure vessel may be changed depending on an operating temperature of the GIS. Therefore, the self-closing force of the vacuum interrupter 20 may be changed, and an opening/closing speed of the vacuum circuit breaker may be affected, which may cause defects, such as incomplete opening, very fast input, or the like. Furthermore, when the self-closing force has an inappropriately large value, an unnecessarily large degree of force may be required for the driving unit or an uneven contact load may be caused.

A vacuum circuit breaker according to an embodiment of the present disclosure may be characterized in that a ratio of self-closing force to a minimum input contact pressure in the vacuum interrupter 20 may be set to a certain ratio.

For example, self-closing force (F_{O}) of the vacuum interrupter 20 at a standard temperature (20° C.) and a rated gas pressure may be defined as in Equation 1 below:

$${F}_{O} = {A}_{B} ( P - {P}_{V} ) - {A}_{R} ( P - {P}_{ATM} ) \qquad [ Equation 1 ]$$

In this case, A_{B} is an effective cross-sectional area of the bellows 30, A_{R} is a cross-sectional area of the movable rod 40, P is a gas pressure in the pressure vessel 10, P_{V} is a vacuum pressure in the vacuum interrupter 20, and P_{ATM} is an atmospheric pressure.

The effective cross-sectional area (A_{B}) of the bellows 30 may be obtained, for example, by dividing a pure pressure load (F_{N}) applied to the bellows by a pressure difference (ΔP) between an internal space of the bellows and an external space of the bellows. A main load applied to the movable electrode may be weight of the movable electrode 23, an elastic force of the bellows, and a pressure load due to the pressure difference. Therefore, the pure pressure load (F_{N}) may be obtained by subtracting a sum of the elastic force of the bellows and the weight of the movable electrode 23 from total force applied to the bellows, and the pressure difference (ΔP) may be obtained by subtracting the vacuum pressure from the gas pressure.

When a rated breaking current of the vacuum circuit breaker is 40 kA, an input contact pressure (F_{C}) of the vacuum interrupter 20 may be set to approximately 400 to 450 kgf. The input contact pressure (F_{C}) may be defined as in Equation 2 below:

$${F}_{C} = {F}_{O} + {F}_{S} \qquad [ Equation 2 ]$$

In this case, F_{S} is an elastic force of the contact pressure spring 60.

The minimum input contact pressure (F_{C.MIN}) of the vacuum interrupter 20 may be determined as a lower limit of the input contact pressure (F_{C}).

In this case, the ratio of the self-closing force to the minimum input contact pressure of the vacuum interrupter 20 may be F_{O}/F_{C.MIN}, and may have a range of −0.1 to 0.2. Preferably, the ratio has a range of about 0<F_{O}/F_{C.MIN}≤0.1.

According to an embodiment of the present disclosure as described above, by maintaining the self-closing force (FO) of the vacuum interrupter, which may be generated by the correlation between the effective cross-sectional area (A_{B}) of the bellows 30, the cross-sectional area (A_{R}) of the movable rod 40, the pressure difference (P-P_{ATM}) between the internal space of the pressure vessel 10 and the external space of the pressure vessel 10, and the pressure difference (P-P_{V}) between the internal space of the vacuum interrupter 20 and the external space of the vacuum interrupter 20, to at least 0.1 times or less than the minimum input contact pressure (F_{C.MIN}), the vacuum circuit breaker may be configured such that deviation of self-closing force according to a change of a usage temperature does not affect performance of the vacuum circuit breaker.

In addition, according to an embodiment of the present disclosure, self-closing force may be limited to a predetermined range, to eliminate unnecessary excessive driving force design elements, and, therefore, to provide a vacuum circuit breaker in which temperature changes and pressure fluctuations in the pressure vessel do not affect an opening/closing operation without increasing the number of components or costs.

The above descriptions are may be merely an example of the technical idea of the present disclosure, and those skilled in the art will appreciate that various modifications and variations may be made without departing from the essential characteristics of the present disclosure.

Accordingly, embodiments disclosed in the present disclosure are not intended to limit the technical idea of the present disclosure but to explain it, and the scope of the technical idea of the present disclosure may not be limited by these embodiments. The protection scope of the present disclosure should be interpreted by the following claims, and all technical ideas within the equivalent scope should be interpreted as being included in the scope of the rights of the present disclosure.

### INDUSTRIAL APPLICABILITY

The present disclosure may be useful, for example, for ultra-high voltage gas-insulated switchgears or the like.

1. A vacuum circuit breaker comprising:
a pressure vessel filled with an insulating gas of a predetermined pressure;
a vacuum interrupter disposed in an internal space of the pressure vessel and having a fixed electrode and a movable electrode in a vacuum tube having a vacuum state;
a bellows provided to seal a gap between the vacuum tube and the movable electrode;
a movable rod having one end connected to an end portion of the movable electrode via an insulating link, and capable of penetrating the pressure vessel and reciprocating in an axial direction while maintaining air-tightness;
a driving rod disposed on the other end of the movable rod in an external space of the pressure vessel and transmitting a driving force of a driving unit to the movable rod; and
a contact pressure spring having one end supported by the movable rod and the other end supported by the driving rod,
wherein a ratio of self-closing force to a minimum input contact pressure in the vacuum interrupter is set to be a predetermined ratio.

2. The vacuum circuit breaker of claim 1, wherein the ratio of self-closing force to a minimum input contact pressure in the vacuum interrupter is −0.1 to 0.2.

3. The vacuum circuit breaker of claim 2, wherein the ratio of self-closing force to a minimum input contact pressure in the vacuum interrupter is more than 0 and equal to or less than 0.1.

4. The vacuum circuit breaker of claim 1, wherein self-closing force (F_{O}) of the vacuum interrupter is determined by Equation 1 at a temperature of 20° C., an input contact pressure (F_{C}) of the vacuum interrupter is determined by Equation 2, and a minimum input contact pressure (F_{C.MIN}) of the vacuum interrupter is determined as a lower limit of the input contact pressure (F_{C}):
$${F}_{O} = {A}_{B} ( P - {P}_{V} ) - {A}_{R} ( P - {P}_{ATM} ) \qquad [ Equation 1 ]$$
where A_{B} is an effective cross-sectional area of the bellows, A_{R} is a cross-sectional area of the movable rod, P is a gas pressure in the pressure vessel, P_{V} is a vacuum pressure in the vacuum interrupter, P_{ATM} is an atmospheric pressure,
$${F}_{C} = {F}_{O} + {F}_{S} \qquad [ Equation 2 ]$$
where F_{S} is an elastic force of the contact pressure spring.

5. The vacuum circuit breaker of claim 2, wherein self-closing force (F_{O}) of the vacuum interrupter is determined by Equation 1 at a temperature of 20° C., an input contact pressure (F_{C}) of the vacuum interrupter is determined by Equation 2, and a minimum input contact pressure (F_{C.MIN}) of the vacuum interrupter is determined as a lower limit of the input contact pressure (F_{C}):
$${F}_{O} = {A}_{B} ( P - {P}_{V} ) - {A}_{R} ( P - {P}_{ATM} ) \qquad [ Equation 1 ]$$
where A_{B} is an effective cross-sectional area of the bellows, A_{R} is a cross-sectional area of the movable rod, P is a gas pressure in the pressure vessel, P_{V} is a vacuum pressure in the vacuum interrupter, P_{ATM} is an atmospheric pressure,
$${F}_{C} = {F}_{O} + {F}_{S} \qquad [ Equation 2 ]$$
where F_{S} is an elastic force of the contact pressure spring.

6. The vacuum circuit breaker of claim 3, wherein self-closing force (F_{O}) of the vacuum interrupter is determined by Equation 1 at a temperature of 20° C., an input contact pressure (F_{C}) of the vacuum interrupter is determined by Equation 2, and a minimum input contact pressure (F_{C.MIN}) of the vacuum interrupter is determined as a lower limit of the input contact pressure (F_{C}):
$${F}_{O} = {A}_{B} ( P - {P}_{V} ) - {A}_{R} ( P - {P}_{ATM} ) \qquad [ Equation 1 ]$$
where A_{B} is an effective cross-sectional area of the bellows, A_{R} is a cross-sectional area of the movable rod, P is a gas pressure in the pressure vessel, P_{V} is a vacuum pressure in the vacuum interrupter, P_{ATM} is an atmospheric pressure,
$${F}_{C} = {F}_{O} + {F}_{S} \qquad [ Equation 2 ]$$
where F_{S} is an elastic force of the contact pressure spring.
